(19) United States
(12) Patent Application Publication
(10) Pub. No.: US 2008/0027866 A1
(43) Pub. Date: Jan. 31, 2008

(54) SYSTEM AND METHOD FOR AUTHENTICATING FILE CONTENT

(76) Inventors: MICHAEL A. HALCROW, PFLUGERVILLE, TX (US); EMILY J. RATLIFF, AUSTIN, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/460,034

(22) Filed: Jul. 26, 2006

(51) Int. Cl. G06Q 99/00

(52) U.S. Cl. 705/51

(57) ABSTRACT

A method, system, and computer readable medium for authenticating file system content. In one embodiment of the method of invention, file system content is received or retrieved for content authentication. Security relevant portions of the file content are identified in accordance with specified parse production rules that tokenize the original file content. Next, the identified security relevant portions of the file content are isolated and extracted from the original file content. The extracted security relevant portions of the file content are authenticated by generating a hash value for the extracted portions and comparing the hash value against a prior output of that hash function applied to a trusted snapshot of the same security relevant file content.

### BACKGROUND OF THE INVENTION

1. Technical Field

The present invention relates generally to file system security, and in particular, to a system and method for detecting unauthorized or unintended modifications of file systems or other software. More particularly, the present invention relates to a file authentication technique that reliably authenticates security-relevant file content.

2. Description of the Related Art

The rapid growth in the number and type of computing devices and the proliferation of network-based applications have greatly expanded accessibility to systems and information. The omnipresent accessibility to systems and data through personal computers, hand-held and wireless devices, etc., has placed large-scale systems and data at extreme risk of access and harm by malicious users. Furthermore, some operating systems allow users to bypass the file system and access the raw disk. Under such circumstances, some form of integrity checking is required to detect data corruption resulting from either storage media malfunction or unauthorized intrusions.

Integrity checking of information stored on a potentially unreliable and/or non-secure medium is a key requirement in the field of secure storage systems. Hash functions are often utilized for confirming data integrity. When used to verify data integrity, hash functions generate proxy identifiers representative of the data content and which can be subsequently compared to confirm whether or not the file content has been altered. In one such data integrity confirmation technique, encrypted checksums are generated utilizing cryptographic hash functions to prevent inauthentic checksums from being used to match malicious data modification.

As with most system management functions, the security-performance tradeoff is a significant limitation for implementation of file system hash authentication. A major source of inefficiency in file hash authentication systems results from so-called false positives. A positive result occurs when the hash comparison detects a discrepancy between a trusted hash value representing the file content and the authentication hash used to detect file tampering. As utilized herein, a “false positive” results when the discrepancy is due to a change in the file content that is immaterial to the purpose for which the hash function authentication is conducted. For example, if a hash function is utilized to detect file tampering that compromises host system security, many file content modifications that have no bearing on system security will result in false positives, resulting in a significant loss in overall system performance.

Accordingly, there exists a need for improved file content authentication methods and systems that selectively identifies and accommodates specified system security needs. The present invention addresses this and other needs unaddressed by the prior art.

### SUMMARY OF THE INVENTION

A method, system, and computer readable medium for authenticating file system content are disclosed herein. In one embodiment of the method of invention, file system content is received or retrieved for content authentication. Security relevant portions of the file content are identified in accordance with specified parse production rules that tokenize the original file content. Next, the identified security relevant portions of the file content are isolated and extracted from the original file content. The extracted security relevant portions of the file content are authenticated by generating a hash value for the extracted portions and comparing the hash value against a prior output of that hash function applied to a trusted snapshot of the same security relevant file content.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a data processing system that may be utilized to implement the method and system of the present invention;

FIG. 2 is a simplified block diagram illustrating a system for authenticating file content in accordance with the present invention;

FIG. 3 is a simplified block diagram depicting an authentication module as may be included in the file content authentication system of the present invention;

FIG. 4 illustrates token production rules that may be utilized for identifying security-relevant portions of file content in accordance with one embodiment of the present invention;

FIG. 5A is a simplified block diagram illustrating memory contents including original file content, intermediate token instantiation, and final token instantiation, utilized for identifying security-relevant portions of file content in accordance with one embodiment of the present invention;

FIG. 5B is a simplified block diagram illustrating memory contents including isolated security-relevant token instantiations utilized for extracting security-relevant file system content in accordance with one embodiment of the present invention; and

FIG. 6 is a simplified flow diagram illustrating steps performed during file content authentication in accordance with a preferred embodiment of the present invention.

### DETAILED DESCRIPTION OF ILLUSTRATIVE EMBODIMENT(S)

The present invention is generally directed to a system, method and computer program product for authenticating data integrity in a data processing system to detect unauthorized tampering or other corruption of file system content. The present invention may be advantageously deployed as part of a dedicated file security package such as Tripwire® or integrated as part of the file security checking functionality implemented in a Trusted Computing Platform (TPM). As explained in further detail below, the present invention is designed to improve the flexibility of the file authentication process in a manner that maintains security assurance while reducing false positive security warnings that occur in conventional file authentication techniques.

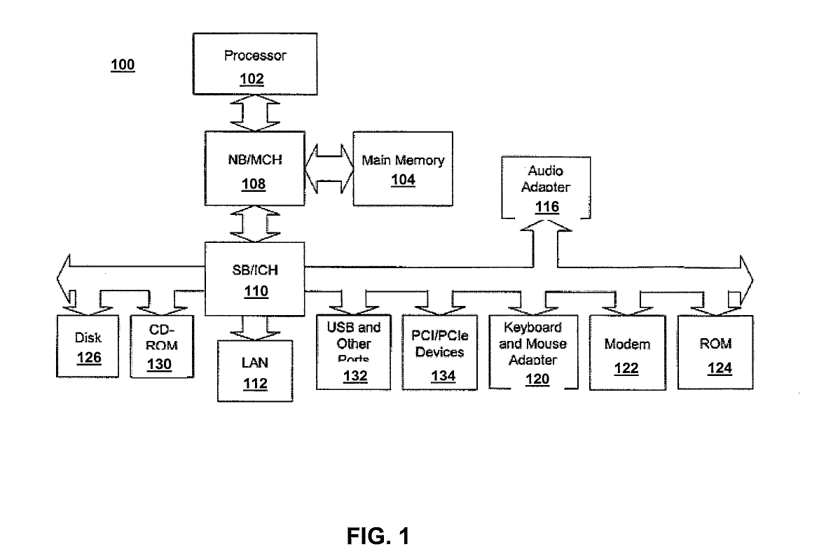

With reference now to the figures, wherein like reference numerals refer to like and corresponding parts throughout, and in particular with reference to FIG. 1, there is depicted a block diagram of a data processing system in which the file content authentication system/method of the present invention may be implemented. Data processing system 100 is generally a computer in which code or instructions implementing the processes of the present invention may be located. In the depicted example, data processing system 100 employs a hub architecture including a north bridge and memory controller hub (MCH) 108 and a south bridge and input/output (I/O) controller hub (ICH) 110. Processor 102 and main memory 104 are connected to MCH 108.

In the depicted example, components connected to ICH 110a include a local area network (LAN) adapter 112, an audio adapter 116, a keyboard and mouse adapter 120, a modem 122, a read only memory (ROM) 124, a hard disk drive (HDD) 126, a CD-ROM driver 130, universal serial bus (USB) ports and other communications ports 132, and peripheral component interconnect (PCI) devices 134. PCI devices 134 may include, for example, Ethernet adapters, add-in cards, PC cards for notebook computers, etc. ROM 124 may include, for example, a flash basic input/output system (BIOS). Hard disk drive 126 and CD-ROM drive 130 may use, for example, an integrated drive electronics (IDE) or serial advanced technology attachment (SATA) interface.

An operating system (not depicted) is loaded in memory 104 and runs on processor 102 to coordinate and provide control of various components within data processing system 100. The operating system may be a commercially available operating system such as Windows XP®, which is available from Microsoft Corporation. An object oriented programming system, such as the Java® programming system, may run in conjunction with the operating system and provides calls to the operating system from Java® programs or applications executing on data processing system 100.

Instructions for the operating system, the object-oriented programming system, and applications or programs are located on storage devices, such as hard disk drive 126, may be loaded into main memory 104 for execution by processor 102. The processes of the present invention may be performed by processor 102 using computer implemented instructions located in a memory such as, for example, main memory 104, ROM 124, or in one or more peripheral devices 126 and 130.

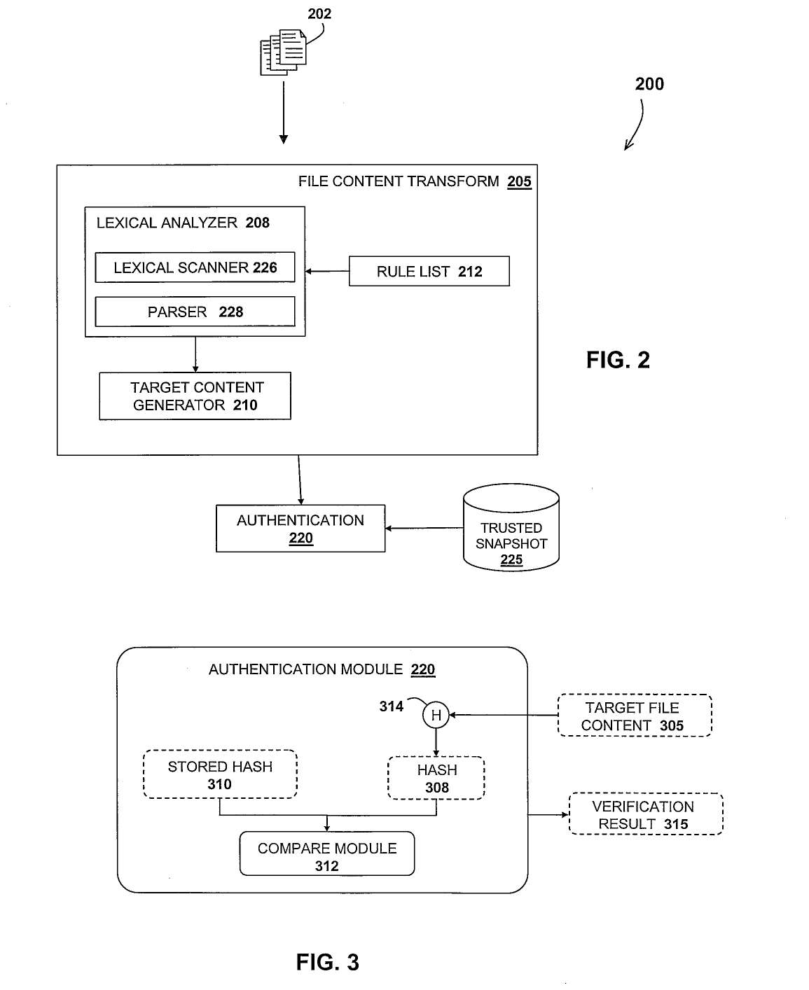

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the present invention may be applied to other processing configurations such as a service processor, multiprocessor data processing system, etc. In a networked environment, program modules depicted relative to data processing system 100 and/or the file content authentication systems depicted and described below with reference to FIGS. 2-6 or portions thereof, may be stored in one or more remote (i.e., network distributed) memory storage devices.

Data processing system 100 may implemented in a personal digital assistant (PDA), which is configured with flash memory to provide non-volatile memory for storing operating system files and/or user-generated data. The depicted example in FIG. 1 and above-described examples are not meant to imply architectural limitations. For example, data processing system 100 also may be implemented as a tablet computer, laptop computer, telephone device, etc.

The software programs incorporated by the file content authentication system depicted in the following figures function as combinations of code modules with each module executing a specific part of the authentication process. In these embodiments, the modules are coupled through defined input and output program calls, and are also coupled to file system and data storage structures through standard commands and calls that provide access to the data stored in the data structures. The instruction protocols between the modules, and between the modules and data structures vary depending on the language in which the modules are written and upon the underlying file security system employed.

Referring to FIG. 2, there is depicted a simplified block diagram illustrating a file content authentication system 200 that generally comprises a file content transform module 205 and an authentication module 220 both of which may be stored and loaded into memory 104 of data processing system 100. Generally, program modules such as transform module 205 and authentication module 220 include routines, programs, components, data structures, etc., that perform particular tasks or implement particular abstract data types. It should be noted that transform module 205 and authentication module 220 as well as other logic functions performed by authentication system 200 may be distributed among multiple computers in a client/server network or may be centralized into a single processor. The functions may also be distributed across processors connected through standard local area networks, wide area networks, dedicated phone lines or other communication means used to loosely couple processors. The software applications forming part of authentication system 200 may be executed under any operating system or platform such as Unix, WindowsXP, or Windows NT, and on industry-standard workstation and/or personal computer hardware.

Authentication module 220 generally contains software and/or hardware borne program instructions executed periodically or in response to a user request for determining whether or not file system content has been corrupted, deliberately or otherwise. The authentication function performed by authentication module 220 fundamentally comprises generating some form of identifier or digital fingerprint, such as a hash value, representing a file content 202 to be verified or authenticated. The identifier generated at authentication time is compared with an identifier stored within a trusted snapshot storage 225. The identifier stored within trusted snapshot storage 225 represents the file content 202 at a time or under a condition attaching an indicia of trustworthiness to the content and the corresponding identifier. In a preferred embodiment, a hash function is utilized as the file content identifier mechanism with resultant hash values stored as reference trusted identifiers within trusted snapshot storage 225.

A significant feature of the present invention is directed to improving the efficiency of using hash functions to authenticate file system content. As utilized herein, authentication of file system content is accomplished when representative digital identifiers, such as hash values representing current and previous file content, are compared to determine that the current file content is identical to a trusted snapshot of the file content. The present invention addresses processing inefficiencies in conventional identifier-based authentication techniques resulting from false positives. A positive result occurs when the authentication comparison process, such as a hash comparison, detects a discrepancy between the identifier representing the file content having a specified level of reliability and the identifier derived to determine authentication at a particular point in time. In this context, a false positive results when the detected discrepancy is due to a difference in file content that is immaterial to the purpose for which the authentication comparison is performed. If, for example, a hash function is utilized to detect file tampering that compromises host system security, many file content modifications that have no bearing on system security will result in false positives, resulting in a significant loss in overall system performance. As a more specific example, a configuration file utilized to configure the initial settings of a computer often includes mission critical content, which, if tampered with, may provide a malicious user with unauthorized access to various system functions. However, configuration files often include content, such as comments, which are not security relevant. The present invention provides a means for reducing or eliminating the inefficiencies attendant to false positives while preserving reliable and secure identifier-based file content authentication.

With continued reference to FIG. 2, authentication module 220 is logically coupled, via system calls or otherwise, to transform module 205, which includes software and/or hardware program processing means for identifying security-relevant portions of file content 202 and extracting and isolating the identified security-relevant content to be processed by authentication module 220. To this end, and as depicted in FIG. 2, transform module 205 generally comprises a lexical analyzer 208 that parses input data content 202 into a lexical token stream, and further includes a target content generator 210 that converts the token stream into a transformed version of file content 202 suitable for authentication.

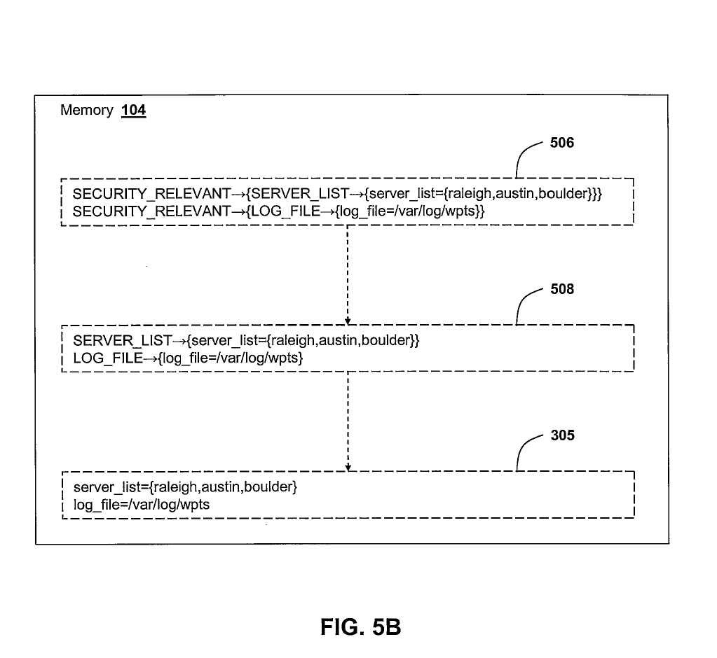

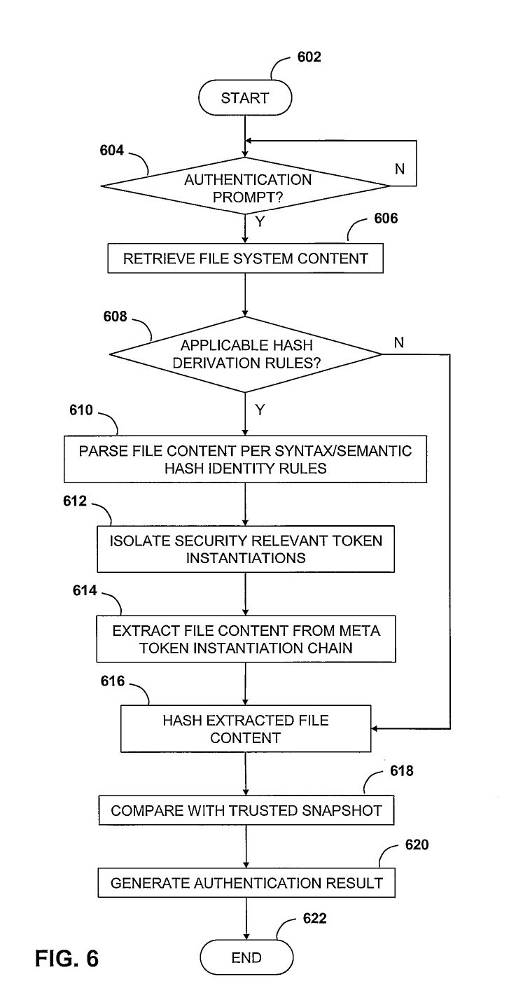

As explained in further detail below with reference to FIGS. 5A and 6, lexical analyzer 208 includes program instructions executed by a suitable processor for identifying security-relevant portions of a file content such as file content 202. Lexical analyzer 208 receives an input string of characters from the content of an input file content 202 and generates therefrom a sequence of symbols referred to as “tokens” or “lexical tokens.” The generated tokens are processed by target content generator module 210 to isolate security-relevant portions of the original file content 202 suitable for use in authentication/authentication in accordance with the invention.

As shown in FIG. 2, lexical analyzer 208 comprises several distinct processing functions. The first function is implemented by a lexical scanner 226 which operates as a finite state machine (FSM), reading through the input string character by character and assuming specified states based on each encountered character. When the scanner FSM assumes an accepting state, it detects the character type and acceptance string position and continues processing the string. Upon assuming a “dead” or non-accepting state, scanner 226 returns to the last accepting state, thus obtaining the type and length of the longest valid string of characters of a specified type referred to in the art as a lexeme. Lexical scanner 226 further includes an evaluator stage (not depicted) to construct tokens from the lexemes. The evaluator produces a value from the characters of a lexeme, resulting in a token constituted from the lexeme's type combined with its value. Those skilled in the art will appreciate that the foregoing description of lexical scanning is simplified and that many variations of lexical analysis procedure are possible without departing from the spirit or scope of the present invention. For example, per conventional lexical scanning, punctuation and other syntactic-type tokens do not strictly speaking have values, so the evaluator function for these characters returns nothing. Moreover, evaluator functions for numbers, identifiers, and strings are typically more complex than described herein.

The tokenized input character stream generated by lexical scanner 226 is processed by a parser module 228. Specifically, lexical scanner 226 passes to parser module 228, a stream of indivisible tokens. Parser module 228 generates a parse tree from the tokens in a parsing instantiation technique in which the original file content is encapsulated and preserved as layered token objects as depicted and described in further detail below.

The tokenization of file content 202 is performed in accordance with specified token production rules 212 incorporated by lexical analyzer 208. Conventionally, token production rules, sometimes referred to as parsing grammars or parsers, are utilized during program compilation, data compression, and other parsing-related processes to construct a parse tree that provides a hierarchical representation of the syntactic structure of an input string. The aforementioned lexical scanning process, for example, would be performed in accordance with such rules in which a resulting tokenized data structure instantiation captures and retains the original file content.

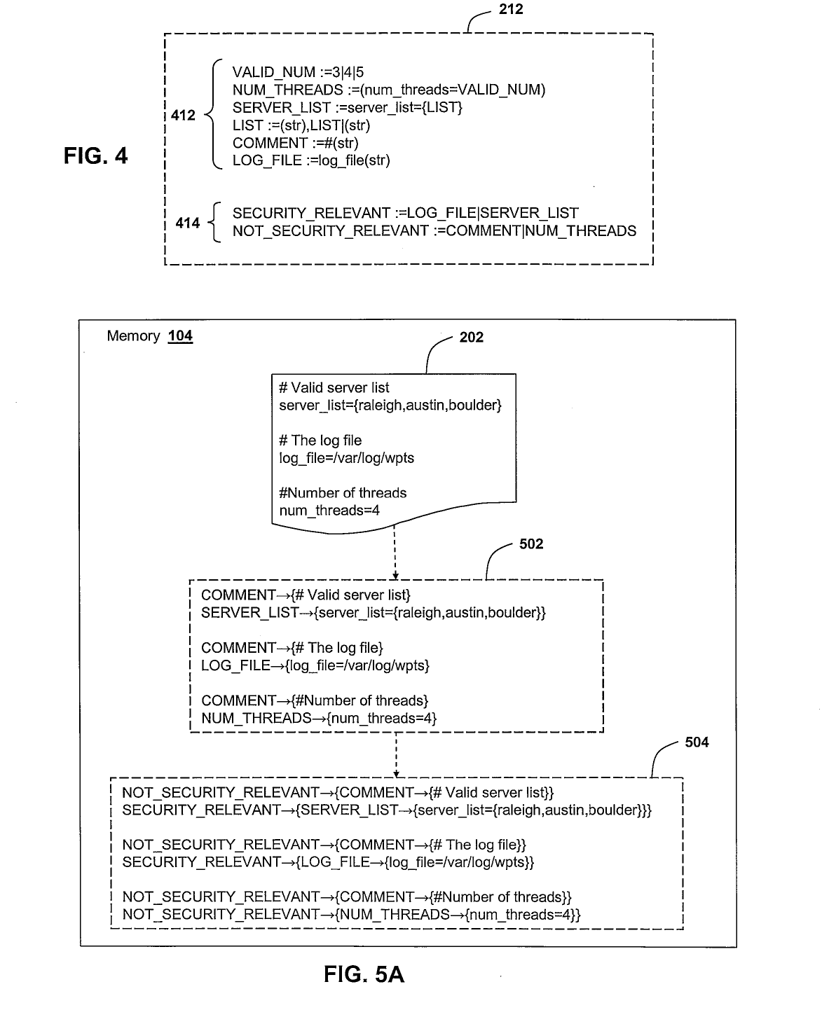

FIG. 4 illustrates the expression grammar of a set of exemplary token production rules 212 that may be utilized for identifying security-relevant portions of file content in accordance with the present invention. Token production rules 212 generally comprise a first set of first-level parse rules 412 that generally includes rules for tokenizing the input file content 202 into symbol objects that can be more efficiently processed. In the exemplary embodiment, first-level parse rules 412 are illustrated as expression grammar rules utilized by lexical scanner 226 to generally simplify semantic identification of the character strings from input data content 202. In accordance with the present invention, the semantic checking simplification is ultimately directed to identifying and discriminating between portions of file content 202 that are material to a given data authentication process, such as that performed by authentication module 220 (i.e. security-relevant), and those portions of file content 202 that are not material to the authentication process (i.e. not security-relevant). To this end, token production rules 212 further include a set of second-level parse rules 414 that define the final criteria for determining whether or not file content is relevant to the subsequent authentication/authentication processing as will be illustrated and described further below.

A memory content structure depicted in FIG. 5A provides a representative demonstration of a hierarchical parse tree structure inherent in the multi-layered token structure generated by the scan and parse functions of lexical analyzer 208. As shown in the depicted embodiment, exemplary input file content 202 includes comment statements # Valid server list, # The log file, and # Number of threads, each designated by the pre-pended # flag identifying each as a comment line. File content 202 further includes non-comment lines server_list={raleigh,austin,boulder}, log_file=/var/log/wpts, and uum_threads=4. The scanning functionality implemented by lexical scanner 226 scans file content 202, and in accordance with first-level parse rules 412, generates an intermediate token instantiation 502 in which file content strings are identified and associated with specified token objects COMMENT, SERVER_LIST, LOG_FILE, and NUM_THREADS. The depicted intermediate token instantiation 502 is an annotated language data structure linking the various strings constituting input file content 202 to the illustrated intermediate-level token objects in accordance with the token definitions provided by first-level parse rules 412.

The intermediate-level token objects generated in accordance with first-level rules 412 are collectively or individually passed as input to parser module 228. While intermediate token instantiation 502 is depicted as collectively including all of the intermediate tokenized strings, it should be noted that parser module 228 may be called to process the collection of tokens represented within block 502 subsequent to processing by lexical scanner 226, or may alternatively be called as an interleaved subroutine by lexical scanner 226 to process each intermediate token individually. In either case, parser module 228 processes intermediate level tokens COMMENT, SERVER_LIST, LOG_FILE, and NUM_THREADS in accordance with second-level parse rules 414 to generate the final level of tokenization represented in FIG. 5A as final token instantiation 504. As shown in FIG. 4, second-level parse rules 414 define the intermediate-level token objects LOG_FILE and SERVER_LIST as being relevant to the authentication process by including these objects in the expression grammar rule that parser module 228 utilizes to instantiate these objects into the meta token SECURITY_RELEVANT object. The depicted second-level parse rules further expressly define intermediate tokens COMMENT and NUM_THREADS as not being relevant to the authentication process by including these objects in the expression grammar rule that parser module 228 utilizes to instantiate these objects into the meta token NOT_SECURITY_RELEVANT object. Consequently, each of the the intermediate-level token objects within intermediate token instantiation 502 are instantiated within either the SECURITY_RELEVANT or NOT_SECURITY_RELEVANT objects within final token instantiation 504. Consistent with object-oriented data encapsulation, and as pictorially depicted in FIG. 5A, all data and object instantiations originating from input file content 202 through intermediate token instantiations 502 are preserved in the meta token objects within final token instantiation 504.

Following the security relevance designations imparted by parser module 228, target content generator 210 is called to process the meta token objects contained within final token instantiation 504 to generate the transformed version of input file content 202 that is utilized for file content authentication. A memory content structure depicted in FIG. 5B provides a representative demonstration of the traversal by target content generator 210 of the multi-layered token structure generated by the scan and parse functions of lexical analyzer 208. Fundamentally, target content generator 210 includes program instructions for processing final token instantiation 504 to isolate and extract the security-relevant portions of the original input file content which can then be authenticated by authentication module 220. To this end, target content generator 210 first extracts and concatenates the SECURITY_RELEVANT meta token objects, or conversely may filter out the NOT_SECURITY_RELEVANT meta token objects, to generate a security relevant token instantiation 506 that excludes all meta tokens expressly or inferentially identified by token production rules 212 as not security relevant. Next, target content generator 210 extracts the intermediate-level tokens SERVER_LIST and LOG_FILE to generate intermediate security relevant token instantiation 508. Target content generator 210 completes the extraction and isolation process by extracting the portions of file content server_list={raleigh,austin,boulder}, log_file=/var/log/wpts into a target file content data structure 305 which is processed by authentication module 220 to verify the integrity of the original file content 202 as explained below with reference to FIG. 6.

FIG. 3 depicts a simplified block diagram representation of the constituent features of exemplary authentication module 220 in accordance with a preferred embodiment of the present invention. As shown in FIG. 3, authentication module 220 generally comprises a one-way hash module 314 logically coupled to a compare module 312. Generally, hash module 314 employs a hash function to convert variable-length strings, such as target file content 305 generated by target content generator 210, into a fixed-length and typically dramatically shortened hash value 308. Associated with hash module 314 are circuit and/or program module means adapted to receive or retrieve the target file content string 305.

Compare module 312 includes circuit and/or program module means for receiving and comparing locally generated hash value 308 with a pre-stored, trusted hash value 310 previously generated from the same file(s). Authentication module 220 completes the authentication processing by sending a authentication result or corresponding message or command 315 to an associated file security application (not depicted). Specifically, responsive to compare module 312 finding a match between the newly generated hash value and the pre-stored hash value, authentication module 220 informs the associated file security that authentication is complete and indicates no discrepancy in the file system condition. If the generated hash 308 is found not to match trusted hash 310, authentication result preferably constitutes a warning, instruction or command issued to the associated file security application.

Referring to FIG. 6, there is depicted a simplified flow diagram illustrating file content authentication steps performed such as by authentication system 200 in accordance with a preferred embodiment of the present invention. The process begins as shown at steps 602 and 604 with the system waiting for and responding to an autonomically or manually scheduled or a user prompted request for a file content authentication cycle. As depicted at step 606, responsive to receiving a system or user authentication cycle prompt, file system content, in the form of one or more file inputs, is received, retrieved or otherwise produced as input to authentication system 200.

Coincident with, or previous or subsequent to the authentication prompt at step 604, a determination is made such as by authentication module 220 and/or transform module 205 of whether the authentication process includes a file content transformation sub-process (step 608). If not, a conventional hash authentication process commences at steps 616 and 618 with the authentication of the entire file content received at step 606. The file content authentication comprises generating a hash of the input file content 202 and comparing the generated hash with a trusted hash value 310 derived from the same file. An authentication result is then generated as described with reference to FIG. 3 and the hash authentication process ends as shown at step 622.

Returning to inquiry block 608, if the authentication process, either inherently or by selective determination, includes a file content transformation sub-process, the process continues as shown at step 610 with the input file content 202 being scanned/parsed in accordance with token production rules 212. After obtaining the final meta token results designating portions of the file content as either security-relevant or not, such as by token object instantiations within final token instantiation 504, target content generator 310 isolates the identified security-relevant tokens into security relevant token instantiation 506 (step 612). Following token isolation within a data structure such as token instantiation 506 that includes only tokens representing security relevant file content, target content generator 210 extracts the object-instantiated file content linked to the isolated tokens by following the token instantiation chain as shown at step 614.

Following the identification, isolation, and extraction of the security-relevant portions of the input file content performed as depicted at steps 610, 612, and 614, the resultant target file content 305 is compared by authentication module 220 with a pre-stored hash 310 that was derived using the same identification, isolation and extraction steps at some previous time or condition attaching a sufficient indicia of trustworthiness (step 618). A authentication result, such as that described above with reference to FIG. 3 is generated at step 620 and the file content authentication process ends as shown at step 622.

The foregoing embodiments provide an efficient means for filtering out non-security-relevant portions of the original file before taking the hash of the file. An alternate embodiment improves upon the flexibility of verifying that security relevant portions of a file have not been altered by accounting for the security relevance of changes in the order of data within a file. A change in the order of file data within a configuration file rarely constitutes a security threat to a system. In the alternate embodiment, the tokens similar to those described above with reference to the figures may be represented and verified hierarchically using a hash tree. Each primitive token (tokens generated from the original instantiated file data) has a hash value. For instances in which the data and corresponding token order is classified as security relevant, the order tuple is represented as a set of children to a node in a hash tree. The parent nodes of ordered sets of children nodes are the hashes of those children nodes arranged in the correct order. These tokens in the tree are flagged as the ones that need to be verified. This configuration is scalable all the way up to the entire configuration file by applying this rule recursively; any order that is necessary is enforced, while any order that is not security relevant is not included as a required rule.

The process of verifying a file hierarchically in this manner would entail the tokenizing step, filtering down to only the security relevant non-terminal symbols (similarly to the procedure described above with reference to the figures), and determining if those security relevant symbols can be arranged into a trusted template hash tree, such as a Merkle hash tree structure. If the security relevant symbols can be arranged into a trusted template hash tree structure, the security relevant symbols are included and the hashes are verified for the flagged nodes. The advantage of this approach is improved flexibility in accounting for non-security relevant aspects of file ordering. Another advantage is that only the root hash value needs to be stored in a trusted, secure manner since all hash values will be verified from root value due to the hash tree properties.

While the invention has been particularly shown and described with reference to a preferred embodiment, it will be understood by those skilled in the art that various changes in form and detail may be made therein without departing from the spirit and scope of the invention.

What is claimed is:

1. A method for authenticating file content comprising:
identifying security relevant portions of a file content;
isolating the identified security-relevant portions from the file content; and
authenticating the isolated security relevant portions of the file content.

2. The method of claim 1, wherein said authenticating comprises:
generating a hash value for the isolated security relevant portions of the file content; and
comparing the generated hash value with a trusted hash value.

3. The method of claim 2, wherein said identifying, isolating, and generating steps are preceded by performing said identifying, isolating, and generating steps to generate the trusted hash value.

4. The method of claim 1, wherein said identifying security relevant portions of a file content comprises lexically parsing the file content using security relevance tokenization rules.

5. The method of claim 4, wherein said lexically parsing the file content comprises tokenizing the file content into tokens representing security-relevant file content and tokens representing non-security-relevant file content.

6. The method of claim 5, said isolating further comprising generating a data structure containing only the tokens representing security-relevant portions of the file content, said tokens concatenated within the data structure in a specified order within a token instantiation chain.

7. The method of claim 6, further comprising:
extracting the file content from the token instantiation chain; and
hashing the extracted file content.

8. A file content authentication system comprising:
processing means for identifying security relevant portions of a file content;
processing means for isolating the identified security-relevant portions from the file content; and
processing means for authenticating the isolated security relevant portions of the file content.

9. The file content authentication system of claim 1, wherein said processing means for authenticating comprises:
processing means for generating a hash value for the isolated security relevant portions of the file content; and
processing means for comparing the generated hash value with a trusted hash value.

10. The file content authentication system of claim 8, wherein said processing means for identifying security relevant portions of a file content comprises processing means for lexically parsing the file content using security relevance tokenization rules.

11. The file content authentication system of claim 10, wherein said processing means for lexically parsing the file content comprises processing means for tokenizing the file content into tokens representing security-relevant file content and tokens representing non-security-relevant file content.

12. The file content authentication system of claim 11, said processing means for isolating further comprising processing means for generating a data structure containing only the tokens representing security-relevant portions of the file content, said tokens concatenated within the data structure in a specified order within a token instantiation chain.

13. The file content authentication system of claim 12, further comprising:
processing means for extracting the file content from the token instantiation chain; and
processing means for hashing the extracted file content.

14. A computer-readable medium having encoded thereon computer-executable instructions for authenticating file content, said computer-executable instructions performing a method comprising:
identifying security relevant portions of a file content;
isolating the identified security-relevant portions from the file content; and
authenticating the isolated security relevant portions of the file content.

15. The computer-readable medium of claim 14, wherein said authenticating comprises:
generating a hash value for the isolated security relevant portions of the file content; and
comparing the generated hash value with a trusted hash value.

16. The computer-readable medium of claim 15, wherein said identifying, isolating, and generating steps are preceded by performing said identifying, isolating, and generating steps to generate the trusted hash value.

17. The computer-readable medium of claim 14, wherein said identifying security relevant portions of a file content comprises lexically parsing the file content using security relevance tokenization rules.

18. The computer-readable medium of claim 17, wherein said lexically parsing the file content comprises tokenizing the file content into tokens representing security-relevant file content and tokens representing non-security-relevant file content.

19. The computer-readable medium of claim 18, said isolating further comprising generating a data structure containing only the tokens representing security-relevant portions of the file content, said tokens concatenated within the data structure in a specified order within a token instantiation chain.

20. The computer-readable medium of claim 19, said method further comprising:
extracting the file content from the token instantiation chain; and
hashing the extracted file content.
